(19) United States
(12) Patent Application Publication
(10) Pub. No.: US 2026/0180895 A1
(43) Pub. Date: Jun. 25, 2026

(54) Handling of Authenticated Device Move Between Link Aggregation Peer Devices

(71) Applicant: Arista Networks, Inc., Santa Clara, CA (US)

(72) Inventors: Joseph Anthony Fitzpatrick, Dublin (IE); Manish Singhvi, Bengaluru (IN)

(21) Appl. No.: 18/988,621

(22) Filed: Dec. 19, 2024

(51) Int. Cl. H04L 45/24; H04L 9/40

(52) U.S. Cl. CPC H04L 45/245; H04L 63/08

(57) ABSTRACT

A network may include first and second link aggregation peers. A device may be authenticated for network access on an interface of the first link aggregation peer and may subsequently be moved to connect to and authenticate for network access on an interface of the second link aggregation peer. The first and second link aggregation peer network devices may be configured to detect the move of the authenticated device and perform the corresponding operations to facilitate appropriate traffic handling for the authenticated device after the authenticated device move.

### BACKGROUND

This relates to network devices such as network devices configured to authenticate supplicant devices for network access.

The network devices that authenticate supplicant devices can also implement link aggregation groups. For example, a link aggregation group can be implemented for links of two distinct network devices (implemented on two distinct chassis) to a common device. The two network devices can coordinate operations to implement a multi-chassis link aggregation group (MLAG) for links between the corresponding interfaces of the two network devices to the common device.

### BRIEF DESCRIPTION OF THE DRAWINGS

FIG. 1 is a diagram of an illustrative network with network devices in accordance with some embodiments.

FIG. 2 is a diagram of an illustrative network device in accordance with some embodiments.

FIG. 3 is a diagram of an illustrative network device configured to maintain information of local authenticated devices and information of devices connected to its link aggregation peer in accordance with some embodiments.

FIG. 4 is a diagram of two illustrative link aggregation peers including a first link aggregation peer connected to a local authenticated device in accordance with some embodiments.

FIG. 5 is a diagram of two illustrative link aggregation peers including a second link aggregation peer connected to an authenticated device previously connected to a first link aggregation peer in accordance with some embodiments.

FIG. 6 is a diagram of two illustrative link aggregation peer network devices with their corresponding resulting device states based on an authenticated device move in accordance with some embodiments.

FIG. 7 is a flowchart of illustrative operations for operating a network device, from which a local authenticated device moves, in accordance with some embodiments.

FIG. 8 is a flowchart of illustrative operations for operating a network device, to which a peer-authenticated device moves, in accordance with some embodiments.

### DETAILED DESCRIPTION

A network can convey network traffic (e.g., in the form of frames, packets, and/or other formats) between hosts or generally between devices. In some illustrative configurations, the network can include network devices that implement link aggregation groups (LAGs). These network devices are sometimes referred to as link aggregation (network) devices. In some illustrative configurations sometimes described herein as an example, separate network devices (e.g., having separate chassis) may collectively form a link aggregation group to a common device via corresponding interfaces on the separate network devices. These link aggregation groups may sometimes be referred to as multi-chassis or multi-device link aggregation groups (MLAGs). Accordingly, these types of link aggregation devices implement LAGs that terminate at multiple (e.g., two) peer devices may sometimes be referred to MLAG network devices, link aggregation peers, link aggregation peer devices, link aggregation peer network devices, or generally link aggregation devices.

In certain deployments, a supplicant device may be authenticated on a local interface of a first link aggregation peer to connect to a network. However, issues may arise when the authenticated device moves to a second link aggregation peer to connect to the network. In particular, without manual intervention, the first and second link aggregation peers may not be aware of the move of the authenticated device and/or may not accurately update their respective states to reflect the move of the authenticated device. This can cause network traffic for the authenticated device to be dropped (e.g., blackholed) at the first link aggregation peer (e.g., because network traffic for the authenticated device is received at the first link aggregation peer, even though the authenticated device is no longer connected at the first link aggregation peer).

To mitigate these issues and provide an automatic mechanism for handling authenticated device moves, the first and second link aggregation peers may update their respective states, based on exchanged information, to reflect the move of the authenticated device. In particular, the second link aggregation peer (to which the authenticated device is moved) may determine that the authenticated device has moved from the first link aggregation peer based on maintained information of peer-connected devices received from the first link aggregation peer. The second link aggregation peer may further inform the first link aggregation peer of the move of authenticated device based on the determination of authenticated device move made by the second link aggregation peer. Additional details of the operations of the link aggregation peers in response to authenticated device moves are further described herein.

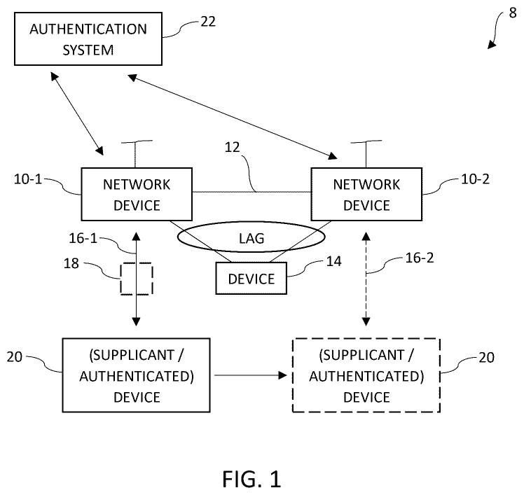

An illustrative network that includes network devices that both facilitate network access control (e.g., host authentication) and manage link aggregation groups is shown in FIG. 1. A network such as network 8 of FIG. 1 may form part of one or more larger networks of any suitable scope, may include one or more networks of any suitable scope, and/or may generally be of any suitable scope. As examples, network 8 may include, be, and/or form part of one or more local segments, one or more local subnets, one or more local area networks (LANs), one or more datacenter networks, one or more campus area networks, one or more metropolitan area networks, one or more wide area networks, etc.

In general, network 8 may include one or more wired portions with network devices interconnected based on wired technologies or standards such as Ethernet (e.g., using copper cables and/or fiber optic cables) and, if desired, one or more wireless portions implemented by wireless network devices (e.g., to form wireless local area networks (WLANs)). If desired, network 8 may include internet service provider networks (e.g., the Internet) or other public service provider networks, private service provider networks (e.g., multiprotocol label switching (MPLS) networks), and/or may include other types of networks such as telecommunication service provider networks.

Network 8 may be implemented using network devices that handle (e.g., process by modifying, forwarding, routing, etc.) network traffic to convey information for user applications between end hosts and/or generally for other applications between devices. Network 8 can include networking equipment forming a variety of network devices that interconnect end hosts of network 8. Each network device in network 8 (e.g., network device 10-1, network device 10-2, device 14 when implemented as a network device, device 18 when implemented as a network device, device 20 when implemented as a network device, etc.) may be a wireless access point, a network switch (e.g., a multi-layer (Layer 2 and Layer 3) switch, a single-layer (Layer 2) switch, etc.), a bridge, a router, a gateway, a hub, a repeater, a firewall, a device serving other networking functions, management equipment that manages and controls the operation of network device(s), or a device that includes the functionality of two or more of these devices.

End host(s) in network 8 (e.g., device 14 when implemented as an end host device, device 20 when implemented as an end host device, etc.) can include a computer, a server, a portable electronic device such as a cellular telephone or laptop, another type of specialized or general-purpose host computing equipment (e.g., running one or more client-side and/or server-side applications), a network-connected appliance or other network-connected equipment that serves as an input-output device or computing device in a distributed networking system, a device used by network administrators (sometimes referred to as an administrator device), a network service or analysis device, or management equipment that manages and controls the operation of one or more of other end hosts and/or network devices.

In the example of FIG. 1, network 8 includes two illustrative network devices 10-1 and 10-2. Network devices 10-1 and 10-2 may be communicatively coupled to one or more common devices via links from both network devices 10-1 and 10-2. These links from both network devices 10-1 and 10-2 to a common device may be configured on devices 10-1 and 10-2 as a link aggregation group. As an example, device 14 (e.g., a network device or an end host) may be communicatively coupled to network device 10-1 via a first set of one or more links and may be communicatively coupled to network device 10-2 via a second set of one or more links. The first and second sets of links may be configured to form a link aggregation group (LAG) by network devices 10-1 and 10-2 (e.g., by configuring corresponding interfaces forming the links to implement the LAG). To facilitate the communication of information between network devices 10-1 and 10-2 (e.g., for managing the LAGs, sharing state and/or configuration information therebetween, and/or generally coordinating operations therebetween), network device 10-1 may be communicatively coupled to network device 10-2 via one or more peer links 12. A peer link 12 may be coupled to an input-output interface of device 10-1 on one end and coupled to an input-output interface of device 10-2 on the other end. In this context, devices 10-1 and 10-2 may sometimes be referred to as link aggregation peers 10-1 and 10-2, or link aggregation peer devices 10-1 and 10-2.

Additionally, some devices such as device 20 may be communicatively coupled to a given one of the link aggregation peer devices at a time (e.g., and not the other one of the link aggregation peer devices at the same time). In the example of FIG. 1, device 20 (e.g., a network device or an end host device) may be communicatively coupled to an input-output interface of network device 10-1 via communication path 16-1. Through network device 10-1, device 20 may transmit traffic to and/or receive traffic from different parts of network 8, thereby gaining network access. Communication path 16-1 may be formed by direct communication link(s) (e.g., optical and/or Ethernet cable connection(s)), and if desired, may include additional intervening device(s) 18 (e.g., another network device of network 8).

To enable device 20 to access network 8 (e.g., convey traffic to and/or from different parts of network 8), network device 10-1 (serving as the authenticator) may be configured to authenticate device 20 (serving as the supplicant device) for network access. In particular, network device 10-1 may exchange messages with an external authentication system 22 such as an authentication server (e.g., an Authentication, Authorization, and Accounting (AAA) server, a Remote Authentication Dail-In User Service (RADIUS) server, etc.) to facilitate the authentication of device 20. Illustrative configurations in which port-based (interface-based) authentication schemes, such as those compliant or otherwise compatible with the IEEE 802.1X standard, are used to authenticate device 20 on a given interface of network device 10-1 are sometimes described herein as an example.

While device 20 is authenticated for network access at an interface of network device 10-1, device 20 can sometimes be moved (e.g., by a network administrator, to update the network topology, etc.) such that device 20 is connected to network 8 via an input-output interface of network device 10-2 (e.g., the link aggregation peer of network device 10-1) instead of network device 10-1. Without manual intervening, the operations of network devices 10-1 and 10-2 can fail to appropriately account for the move of authenticated device 20 from network device 10-1 to network device 10-2, and as such, network traffic for device 20 may not be appropriately handled (e.g., leading to blackholing or dropping of traffic indicated for device 20 at network device 10-1). Accordingly, in illustrative embodiments described herein, network devices (e.g., devices 10-1 and 10-2) that operate as link aggregation peers may be configured to improve operations in response to these types of authenticated device moves.

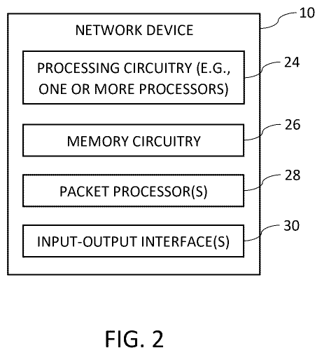

FIG. 2 is a diagram of an illustrative network device (e.g., implementing network devices 10-1 and 10-2 in FIG. 1). As shown in FIG. 2, network device 10 may include processing circuitry 24, memory circuitry 26, one or more packet processors 28, and input-output interfaces 30 (e.g., implemented on corresponding network device ports). Each of these components may be mounted on and/or within a housing or chassis of network device 10. In one illustrative arrangement, network device 10 may be or form part of a modular network device system (e.g., a modular switch system having removably coupled modules usable to flexibly expand characteristics and capabilities of the modular switch system such as to increase the number of ports, provide specialized functionalities, etc.). In another illustrative arrangement, network device 10 may be a fixed-configuration network device (e.g., a fixed-configuration switch having a fixed number of ports and/or a fixed hardware configuration).

Processing circuitry 24 may include one or more processors such as central processing units (CPUs), graphics processing units (GPUs), microprocessors, general-purpose processors, host processors, microcontrollers, digital signal processors, programmable logic devices such as field programmable gate array (FPGA) devices, application specific system processors (ASSPs), application specific integrated circuit (ASIC) processors, and/or other types of processors.

Processing circuitry 24 may run (e.g., execute) a network device operating system and/or other software (including firmware) that is stored on memory circuitry 26. Memory circuitry 26 may include one or more non-transitory (tangible) computer-readable storage media that store the operating system software and/or any other software code, sometimes referred to as program instructions, software, data, instructions, or code. As an example, the network access control operations (e.g., based on the IEEE 802.1X standard) and/or the link aggregation group management operations (e.g., link aggregation control protocol operations such as operations in compliance with or otherwise compatible with Link Aggregation Control Protocol (LACP)) performed by network device 10 as described herein may be stored as (software) instructions on the one or more non-transitory computer-readable storage media (e.g., in portion(s) of memory circuitry 26). The corresponding processing circuitry (e.g., one or more processors of processing circuitry 24) may execute the respective instructions to perform the network access control operations and/or the link aggregation group management operations.

Memory circuitry 26 may include non-volatile memory (e.g., flash memory, electrically-programmable read-only memory, a solid-state drive, hard disk drive storage, etc.), volatile memory (e.g., static random-access memory or dynamic random-access memory), removable storage devices (e.g., storage devices removably coupled to device 10), and/or other types of memory circuitry.

Processing circuitry 24 and (at least a portion of) memory circuitry 26 as described above may sometimes be referred to collectively as control circuitry (e.g., implementing a control plane) for network device 10. As just a few examples, processing circuitry 24 may execute network device control plane software such as operating system software, routing policy management software, routing protocol or other protocol processes (e.g., a link aggregation control protocol process, an interface-based device authentication process, etc.), routing information base processes, and other control software, may be used to support the operation of protocol clients and/or servers (e.g., to form some or all of a communications protocol stack), may be used to support the operation of packet processor(s) 28, may store packet forwarding information, may execute packet processing software, and/or may execute other software instructions that control the functions of network device 10 and the other components therein.

Packet processor(s) 28 may be used to implement a data plane or forwarding plane of network device 10. Accordingly, packet processor(s) 28 may sometimes be referred to as data plane processing circuitry 28. Packet processor(s) 28 may include one or more processors such as programmable logic devices (e.g., field programmable gate array (FPGA) devices), application specific system processors (ASSPs), application specific integrated circuit (ASIC) processors, central processing units (CPUs), graphics processing units (GPUs), microprocessors, general-purpose processors, host processors, microcontrollers, digital signal processors, and/or other types of processors.

Packet processor 28 may receive incoming network traffic via input-output interfaces 30, parse and analyze the network traffic, process the network traffic based on packet forwarding decision data (e.g., in a forwarding information base) and/or in accordance with network protocol(s) or other forwarding policy, and forward (or drop) the network traffic accordingly. The packet forwarding decision data may be stored on memory circuitry integrated as part of and/or separate from packet processor 28 (e.g., on content-addressable memory), and/or on a portion of memory circuitry 26. Memory circuitry for packet processor 28 may include volatile memory and/or non-volatile memory.

Input-output interfaces 30 may include one or more different types of communication interfaces such as Ethernet interfaces, optical interfaces, network layer (e.g., Internet Protocol (IP) such as IPv4 and/or IPv6) interfaces, wireless interfaces such as Bluetooth interfaces and Wi-Fi interfaces, and/or other communication interfaces for connecting network device 10 to the Internet, a local area network, a wide area network, a mobile network, and/or generally other network device(s), peripheral devices, and computing equipment (e.g., host equipment such as server equipment, client devices, etc.). In illustrative configurations described herein as an example, input-output interfaces 30 may include Ethernet interfaces implemented using and therefore including (Ethernet) ports. Data link layer interface circuitry may be coupled to the ports to form Ethernet interfaces with the desired interface configurations.

The illustrative components of device 10 in FIG. 2 is merely illustrative. If desired, device 10 may include other suitable components such as power supply and management circuitry, thermal management components (e.g., heatsinks), etc. Components of network device 10 may generally be communicatively coupled to one another (or at least to processing circuitry 24 and/or memory circuitry 26) via signal paths (e.g., data paths such as a data bus, power supply paths, etc.).

In configurations in which instances of network device 10 in FIG. 2 implements link aggregation group devices (e.g., devices 10-1 and 10-2 in FIG. 1), processing circuitry 24 on network device 10 may execute, based on corresponding instructions stored on memory circuitry 26, a process for managing the link aggregation groups. As examples, this link aggregation group management process may be used to exchange information (e.g., connected-device information, link aggregation group state information, and/or other state information) between link aggregation peers, may be used to handle (e.g., process) traffic received on links forming link aggregation groups, and/or may be used to perform other operations that facilitate the management and operation of link aggregation groups.

In configurations in which instances of network device 10 in FIG. 2 serves as an authenticator for supplicant devices (e.g., devices 10-1 and 10-2 in FIG. 1 for supplicant device 20), processing circuitry 24 on network device 10 may execute, based on corresponding instructions stored on memory circuitry 26, a process for performing network access control (e.g., supplicant device authentication). As examples, this network access control process may be used to exchange messages with supplicant devices, may be used to exchange messages with an authentication server, may be used to appropriate handle (e.g., process) traffic for authenticated and/or non-authenticated devices, and/or may be used to perform other operations that facilitate network access control.

While specific processes are sometimes described herein to perform link aggregation group management operations and network access control operations for device 10, this is merely illustrative. Processing circuitry 24 may be organized in any suitable manner (e.g., to have other processes or agents instead of or in addition to the specific processes described herein) to perform different parts of the link aggregation group management and network access control operations described herein. Accordingly, processing circuitry 24 (or the control circuitry of device 10 formed therefrom) may sometimes be described herein to perform the link aggregation group management and network access control operations described herein instead of specifically referencing one or more agents, processes, and/or the kernel executed by processing circuitry 24 that performs these link aggregation group management and network access control operations.

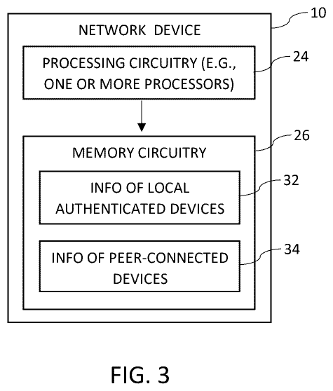

In one illustrative configuration described herein as an example, network devices 10-1 and 10-2 in FIG. 1 may each be implemented using an instance of network device 10 in FIG. 2 having respective processing circuitry 24 configured to perform link aggregation group management and network access control operations as described herein. To facilitate these operations, network device 10 in FIG. 2 (e.g., each of network devices 10-1 and 10-2) may maintain state information for these different operations. FIG. 3 is a diagram of an illustrative network device 10 (e.g., an illustrative configuration of the network device 10 of FIG. 2) maintaining different types of state information based on link aggregation group management and network access control operations.

As shown in FIG. 3, processing circuitry 24 maintain (e.g., store, add, remove, and/or otherwise update) information 32 of local authenticated devices (e.g., supplicant devices authenticated on local input-output interfaces 30 of device 10) on memory circuitry 26. In illustrative configurations sometimes described herein as an example, processing circuitry 24, when performing interface-based network access control operations (e.g., IEEE 802.1X operations) as an authenticator device, may maintain a database (e.g., a table) of entries each of a corresponding local authenticated device. Information 32 may be stored as part of the database of entries of local authenticated devices and may be updated based on the network access control operations. As an example, when a new supplicant device is authenticated on a given input-output interface of device 10 (e.g., as part of the network access control operations or more specifically the supplicant device authentication operations), a new entry containing corresponding information 32 for the newly authenticated device can be added to the database.

Information 32 on each local authenticated device (e.g., in each corresponding entry of the database) may include a Media Access Control (MAC) address of the local authenticated device, the local input-output interface 30 (or port) on device 10 on which the local authenticated device is authenticated, role and/or contextual information about the local authenticated device, and/or other information about the local authenticated device (e.g., in the context of network access control).

As shown in FIG. 3, processing circuitry 24 may also maintain information 34 of peer-connected devices (e.g., supplicant devices authenticated on and connected at input-output interfaces of a link aggregation peer of device 10) on memory circuitry 26. In particular, peer-connected devices authenticated by the link aggregation peer of device 10 may be identified by connectivity information is received from the link aggregation peer (e.g., via peer link 12 in FIG. 1) by processing circuitry 24 of network device 10 (FIG. 3).

In illustrative configurations sometimes described herein as an example, processing circuitry 24, when performing link aggregation group management operations (e.g., link aggregation control protocol operations), may maintain a database (e.g., a table) of entries each for a corresponding peer-connected device. Information 34 may be stored as part of the database of entries of peer-connected devices and may be updated based on the link aggregation group management operations performed by processing circuitry 24 and/or link aggregation group management operations performed by the processing circuitry of the link aggregation peer. As an example, when a new supplicant device is authenticated and connected to a given input-output interface of the link aggregation peer, the link aggregation peer may transmit an indication that the supplicant device is connected to the link aggregation peer to device 10. Accordingly, processing circuitry 24 may store the received indication as information 34 (e.g., thereby adding an entry in the database for the new peer-connected device).

Information 34 on each peer-connected device may include a Media Access Control (MAC) address of the local authenticated device, the interface (or port) on the link aggregation peer on which the peer-connected device is authenticated and connected, and/or other information about the peer-connected device (e.g., in the context of link aggregation group management).

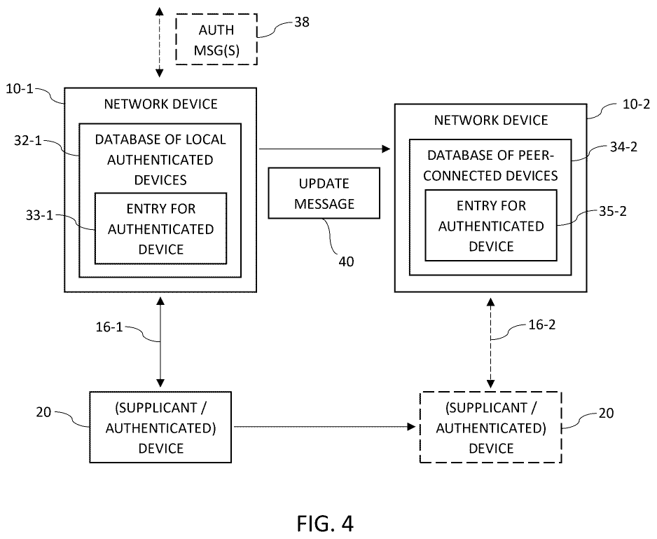

FIGS. 4-6 show the illustrative configurations of network device 10-1 (e.g., implemented as a first instance of device 10 of FIG. 2 and configured in the manner described in connection with FIG. 3) and network device 10-2 (e.g., implemented as a second instance of device 10 of FIG. 2 and configured in the manner described in connection with FIG. 3) operating as (multi-chassis) link aggregation peer network devices. In particular, network devices 10-1 and 10-2 as described in connection with FIGS. 4-6 may detail operations described above in connection with FIG. 1 with respect to an authenticated device move (e.g., authenticated device 20 moving from network device 10-1 to network device 10-2).

FIG. 4 is a diagram of illustrative operations of link aggregation peer network devices 10-1 and 10-2 in connection with an initial network state in which a supplicant device 20 is communicatively coupled to an input-output interface 30 of network device 10-1 via path 16-1. Supplicant device 20 may request network access via the input-output interface 30 of network device 10-1 (serving as an authenticator device). In some illustrative configurations, network device 10-1 (e.g., processing circuitry 24 of network device 10-1) may exchange authentication messages 38 with external equipment (e.g., an authentication server or generally another type of authentication system 22 in FIG. 1), based on received from device 10 as part of the network access request, to authenticate and provide network access to device 20 at the input-output interface 30 of network device 10-1.

Processing circuitry 24 of network device 10-1 may maintain a database 32-1 of local authenticated devices (e.g., by storing entries of corresponding local authenticated devices in memory circuitry 26 of network device 10-1 containing local authenticated device information 32, in the manner described in connection with FIG. 3). Based on supplicant device 20 being authenticated on the input-output interface 30 of device 10-1, processing circuitry 24 of device 10-1 may update database 32-1 to include an indication of authenticated device 20. The indication of device 20 as a local authenticated device may be stored as an entry 33-1 in database 32-1 (or if desired, may be stored or organized in other manners generally as information of local authenticated device 20 on device 10-1).

In particular, the indication of device 20 or entry 33-1 may include the MAC address of authenticated device 20, the input-output interface 30 of device 10-1 on which device 20 is authenticated, the role or contextual information of device 20, and/or other information about device 20. If desired, based on the entry 33-1, processing circuitry 24 of device 10-1 may perform certain control plane operations and/or facilitate certain data plane operations of network device 10-1. As an example, processing circuitry 24 of device 10-1 may configure a port on which device 20 is authenticated based on entry 33-1, e.g., to facilitate the forwarding of traffic to and/or from authenticated device 20 via the configured port.

These operations in connection with the authentication of device 20 and the management (e.g., maintenance) of database 32-1 may be performed in connection with network access control operations (e.g., IEEE 801.1X-compliant operations) performed by processing circuitry 24 of device 10-1.

Additionally, based on the stored indication of device 20 being a new local authenticated device (and/or other relevant changes to the port-connectivity of device 10-1), processing circuitry 24 of device 10-1 may transmit an update message 40 indicating the newly authenticated and connected device 20 to device 10-2. As an example, update message 40 may include the MAC address of authenticated device 20 and the input-output interface of device 10-1 at which device 20 is connected (and on which device 20 is authenticated), among other information. Message 40 may be conveyed across a peer link 12 (FIG. 1) communicatively coupling an input-output interface 30 of device 10-1 to an input-output interface 30 of device 10-2.

In some illustrative configurations described herein as an example, processing circuitry 24 of device 10-1 may generate and transmit update message 40 when performing link aggregation group management operations (e.g., LACP-compliant operations). Accordingly, update message 40 may be an update message compliant with LACP, as one example. This is merely illustrative. If desired, any suitable indication of device 20 being a locally connected device of device 10-1 may be conveyed from device 10-1 to device 10-2.

On the other side, network device 10-2 (e.g., processing circuitry 24 of device 10-2) may maintain a database 34-2 of peer-connected devices (e.g., by storing entries of corresponding peer-connected devices in memory circuitry 26 of network device 10-2 containing peer-connected device information 34, in the manner described in connection with FIG. 3). Based on receiving message 40 (or another indication of device 20 being peer-connected), processing circuitry 24 of device 10-2 may update database 34-2 to include an indication of device 20. The indication of device 20 as a peer-connected device (e.g., as a device connected at an input-output interface of device 10-1) may be stored as an entry 35-2 in database 34-2 (or if desired, may be stored or organized in other manners generally as information of peer-connected device 20).

In particular, the indication of device 20 or entry 35-2 may include the MAC address of peer-connected device 20, the input-output interface 30 of device 10-1 on which device 20 is connected and authenticated, and/or other information about device 20. If desired, based on the entry 35-2, processing circuitry 24 of device 10-2 may perform certain control plane operations and/or facilitate certain data plane operations of network device 10-2. As an example, processing circuitry 24 of device 10-2 may perform operations that facilitate the forwarding of traffic to and/or from authenticated device 20 via peer network device 10-1 based on the entry 35-2.

These operations in connection with the reception and processing of message 40 and the management (e.g., maintenance) of database 34-2 may be performed in connection with link aggregation group management operations (e.g., LACP-compliant operations) performed by processing circuitry 24 of device 10-2.

While device 20 is connected at the input-output interface of device 10-1 on which device 20 is authenticated for network access, network devices 10-1 and 10-2 may operate in a satisfactory manner, e.g., to handle network traffic for authenticated device 20. However, in some scenarios, the accessing device to network 8 for authenticated device 20 may change from network device 10-1 to network device 10-2. As shown in the example of FIG. 4 (and similarly shown and described in connection with FIG. 1), authenticated device 20 may move from its network location of being connected at an input-output interface 30 of device 10-1 via link 16-1 to a new network location of being connected at an input-output interface 30 of device 10-2 via link 16-2. Without detecting and addressing this authenticated device move, the configurations of devices 10-1 and 10-2 may no longer operate in a satisfactory manner to handle traffic for authenticated device 20 (now connected to an interface of device 10-2).

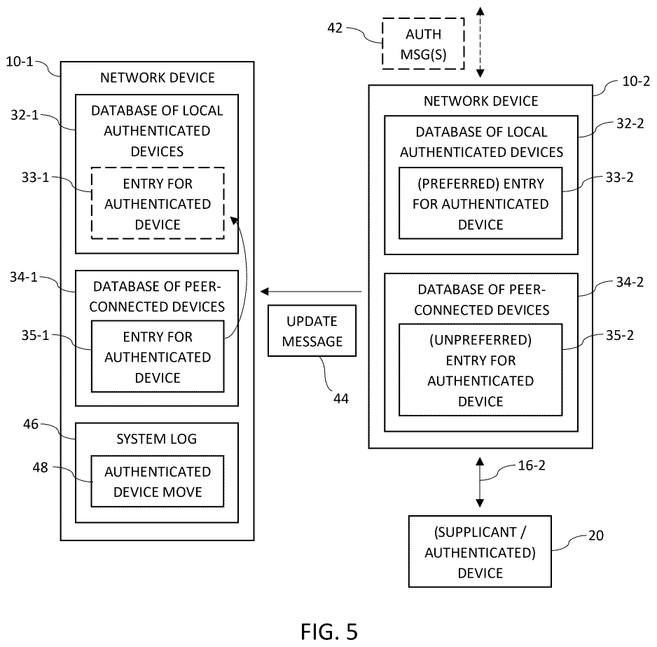

FIG. 5 shows illustrative configurations of network devices 10-1 and 10-2 and operations performed by network devices 10-1 and 10-2 in response to the move of authenticated device 20 from device 10-1 to device 10-2. In the example of FIG. 5, device 20 may be newly coupled communicatively to an input-output interface 30 of network device 10-2 via path 16-2 (e.g., with or with an intervening device such as device 18 in FIG. 1 along path 16-2).

Based on its new network location, supplicant device 20 may request network access via the input-output interface 30 of network device 10-2 (serving as an authenticator device). In some illustrative configurations, network device 10-2 (e.g., processing circuitry 24 of network device 10-2) may exchange authentication messages 42 with external equipment (e.g., an authentication server or generally another type of authentication system 22 in FIG. 1), based on credentials received from device 10 as part of the network access request, to authenticate and provide network access to device 20 on the input-output interface 30 of network device 10-2.

Based on device 20 being authenticated the input-output interface 30 of network device 10-2, processing circuitry 24 of device 10-2 may determine whether or not device 20 is also a peer-authenticated device (e.g., whether or not the same device 20 is also authenticated on an interface 30 of peer network device 10-1). In particular, processing circuitry 24 of device 10-2 may determine whether or not device 20 is a peer-authenticated device based on whether or not there is a stored indication of device 20 being a peer-connected device (and therefore, in this context, a peer-authenticated device). As an example, a peer-connected device entry existing in database 34-2 may serve as the indication of a device being a peer-connected device.

As such, based on identifying entry 35-2 corresponding to device 20 (e.g., containing a MAC address that matches that of device 20, as locally authenticated), processing circuitry 24 of device 10-2 may determine that newly authenticated device 20 is also a peer-authenticated (and peer-connected) device. Based on device 20 being both peer-authenticated and locally authenticated, processing circuitry 24 of device 10-2 may indicate a preference for device 20 being locally authenticated rather than being peer-authenticated. In other words, processing circuitry 24 may associate a higher preference (value) for an entry indicative of device 20 being locally authenticated and associate a lower preference (value) for an entry indicative of device 20 being peer-authenticated.

As shown in the example of FIG. 5, processing circuitry 24 of network device 10-2 may maintain a database 32-2 of local authenticated devices (e.g., by storing entries of corresponding local authenticated devices in memory circuitry 26 of network device 10-2 containing local authenticated device information 32, in the manner described in connection with FIG. 3). Based on device 20 being authenticated on a local interface 30 of device 10-2, processing circuitry 24 of device 10-2 may update database 32-2 to include an indication of authenticated device 20. The indication of device 20 as a local authenticated device may be stored as an entry 33-2 in database 32-2 (or if desired, may be stored or organized in other manners generally as information of local authenticated device 20 on device 10-2).

In particular, the indication of device 20 or entry 33-2 may include the MAC address of authenticated device 20, the input-output interface 30 of device 10-2 on which device 20 is authenticated, the role or contextual information of device 20, and/or other information about device 20. If desired, based on the entry 33-2, processing circuitry 24 of device 10-1 may perform certain control plane operations and/or facilitate certain data plane operations of network device 10-1. As described above, processing circuitry 24 of device 10-2 may assign a higher preference to entry 33-2 indicative of local authentication and a lower preference to entry 35-2 indicative of peer authentication, thereby effectively overriding the use of entry 35-2 in favor of entry 33-2. As an example, processing circuitry 24 of device 10-2 may configure a port on which device 20 is authenticated based on entry 33-2, e.g., to facilitate the forwarding of traffic to and/or from authenticated device 20 via the configured port, rather than performing other operations based on entry 35-2.

These operations in connection with the authentication of device 20 and the management (e.g., maintenance) of database 32-2 may be performed in connection with network access control operations (e.g., IEEE 801.1X-compliant operations) performed by processing circuitry 24 of device 10-2.

Additionally, based on the stored indication of device 20 being a new local authenticated device (and/or other relevant changes to the port-connectivity of device 10-2), processing circuitry 24 of device 10-2 may transmit an update message 44 indicating the newly authenticated and connected device 20 to device 10-1. As an example, update message 44 may include the MAC address of authenticated device 20 and the input-output interface of device 10-2 at which device 20 is connected (and on which device 20 is authenticated), among other information. Message 40 may be conveyed across a peer link 12 (FIG. 1) communicatively coupling an input-output interface 30 of device 10-2 to an input-output interface 30 of device 10-1.

In some illustrative configurations described herein as an example, processing circuitry 24 of device 10-2 may generate and transmit update message 44 when performing link aggregation group management operations (e.g., LACP-compliant operations). Accordingly, update message 44 may be an update message compliant with LACP, as one example. This is merely illustrative. If desired, any suitable indication of device 20 being a locally connected device of device 10-2 may be conveyed from device 10-2 to device 10-1.

On the other side, network device 10-1 (e.g., processing circuitry 24 of device 10-1), may maintain a database 34-1 of peer-connected devices (e.g., by storing entries of corresponding peer-connected devices in memory circuitry 26 of network device 10-1 containing peer-connected device information 34, in the manner described in connection with FIG. 3). Based on receiving message 44 (or another indication of device 20 being peer-connected), processing circuitry 24 of device 10-1 may update database 34-1 to include an indication of device 20. The indication of device 20 as a peer-connected device (e.g., as a device connected at an input-output interface of device 10-2) may be stored as an entry 35-1 in database 34-1 (or if desired, may be stored or organized in other manners generally as information of peer-connected device 20).

In particular, the indication of device 20 or entry 35-1 may include the MAC address of peer-connected device 20, the input-output interface 30 of device 10-2 on which device 20 is connected and authenticated and/or other information about device 20. If desired, based on the entry 35-1, processing circuitry 24 of device 10-1 may perform certain control plane operations and/or facilitate certain data plane operations of network device 10-1. As an example, processing circuitry 24 of device 10-1 may perform operations that facilitate the forwarding of traffic to and/or from authenticated device 20 via peer network device 10-2 based on the entry 35-1.

These operations in connection with the reception and processing of message 44 and the management (e.g., maintenance) of database 34-1 may be performed in connection with link aggregation group management operations (e.g., LACP-compliant operations) performed by processing circuitry 24 of device 10-1.

Additionally, based on the stored indication of device 20 being peer-connected (e.g., based on entry 35-1), processing circuitry 24 of device 10-1 may determine whether an indication or entry for the same device 20 is stored in database 32-1 of local authenticated devices. In response to identifying entry 33-1 for device 20 in database 32-1, processing circuitry 24 of device 10-1 may remove entry 33-1 from database 32-1 and/or remove other indications of device 20 as a local authenticated device.

Processing circuitry 24 of device 10-1 may maintain a system log 46 that serves as a store of system events. Based on the addition of entry 35-1 in database 34-1 and the removal of entry 33-1 from database 32-1 (and the corresponding determinations that led to these state changes), processing circuitry 24 of device 10-1 may determine that authenticated device 20 has moved from device 10-1 to device 10-2. Accordingly, if desired, processing circuitry 24 of device 10-1 may further store a log entry 48 indicating that authenticated device 20 has moved from device 10-1 to device 10-2 in system log 46. Processing circuitry 24 of device 10-1 may facilitate external access of log 46 (e.g., entry 48 therein) by external equipment (e.g., an administrator device) at a later time.

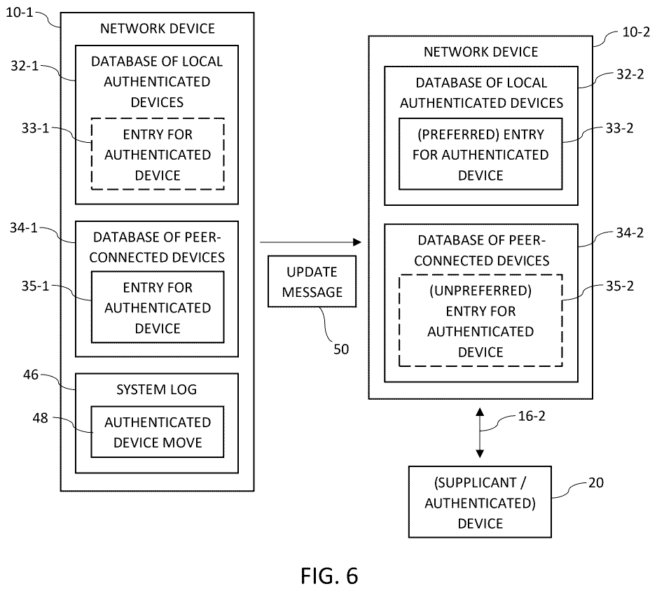

Subsequently, as shown in FIG. 6, based on database 32-1 being updated to remove entry 33-1 (e.g., indicating that device 20 is no longer authenticated on the input-output interface 30 of device 10-1), processing circuitry 24 of device 10-1 may transmit an update message 50, indicating that device 20 is no longer connected at the input-output interface 30 of device 10-1, to device 10-2. As an example, update message 50 may include the MAC address of device 20, the input-output interface 30 of device 10-1 on which device 20 was connected and authenticated, and/or an indication of the removal of device 20 as a locally authenticated and connected device, among other information. Message 50 may be conveyed across a peer link 12 (FIG. 1) communicatively coupling an input-output interface 30 of device 10-1 to an input-output interface 30 of device 10-2.

In some illustrative configurations described herein as an example, processing circuitry 24 of device 10-1 may generate and transmit update message 50 when performing link aggregation group management operations (e.g., LACP-compliant operations). Accordingly, update message 40 may be an update message compliant with LACP, as one example. This is merely illustrative. If desired, any suitable indication of device 20 being no longer a locally connected device of device 10-1 may be conveyed from device 10-1 to device 10-2.

On the other side, based on receiving message 50, processing circuitry 24 of device 10-2 may remove entry 35-2 from database 34-2 and/or remove other indications of device 20 as a peer-authenticated device. These operations in connection with the reception and processing of message 50 and the management (e.g., maintenance) of database 34-2 may be performed in connection with link aggregation group management operations (e.g., LACP-compliant operations) performed by processing circuitry 24 of device 10-2.

Configured in the manner described in connection with FIGS. 5 and 6, network devices 10-1 and 10-2 may automatically (e.g., without manual intervening form an administrator or user) detect the authenticated device move and update the states of devices 10-1 and 10-2 to appropriately address for the authenticated device move, thereby resolving issues with traffic forwarding (e.g., unintentional blackholing of traffic) based on the authenticated device move. In particular, network devices may 10-1 and 10-2 may use the exchanged information of peer-connected devices to determine whether or not a newly authenticated device is an authenticated device that has moved from its peer, thereby enabling the detection of the authenticated device move.

The operations described above in connection with FIGS. 5 and 6 are merely illustrative. If desired, in some instances, once device 20 is connected to and requests network access via network device 10-2 (e.g., at the input-output interface 30 thereof), device 20 may be authenticated by network device 10-2 (e.g., at the input-output interface 30 thereof), after entry 33-1 on network device 10-1 has been removed (from database 32-1). For example, network device 10-2 (e.g., processing circuitry 24 thereof) may authenticate device 20 and store the indication of device 20 as a local authenticated device (e.g., store entry 33-2 in database 32-2), after sending message 44 in FIG. 5 (or another message indicating that entry 33-1 on device 10-1 should be removed) and/or after receiving message 50 in FIG. 6 (or another message indicating that entry 33-1 on device 10-1 has been removed).

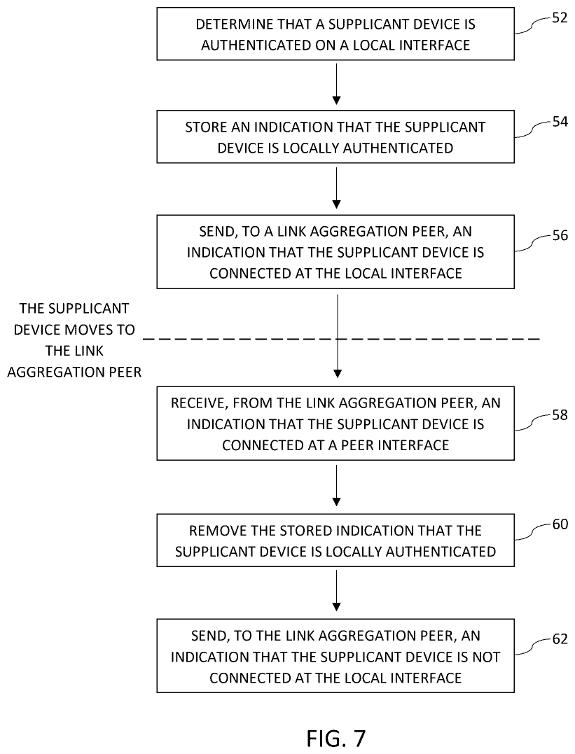

FIG. 7 is a flowchart of illustrative operations performed by one or more network devices such as network devices 10-1 and/or 10-2. The illustrative operations described in connection with FIG. 7 may be performed by one or more processors (e.g., processing circuitry 24 in FIG. 2) in the corresponding network device by executing software instructions stored on respective memory circuitry (e.g., memory circuitry 26 in FIG. 2, including one or more non-transitory computer-readable media). If desired, one or more operations described in connection with FIG. 7 may be performed by other dedicated hardware components in the respective network device.

At block 52, one or more processors of a network device, such as a network device implementing a link aggregation peer group with its link aggregation peer, may determine that a supplicant device is authenticated for network access on a local interface of the network device. For example, the operations performed at block 52 may include the operations performed by processing circuitry 24 of device 10-1 in FIG. 4, in connection with the authentication of device 20 on a given input-output interface 30 of device 10-1.

At block 54, the one or more processors may store an indication that the supplicant device is locally authenticated (e.g., authenticated for network access on the local interface of the network device). For example, the operations performed at block 54 may include the operations performed by processing circuitry 24 of device 10-1 in FIG. 4, in connection with the storage of entry 33-1 (serving as the stored indication) in database 32-1 of local authenticated devices.

At block 56, the one or more processors may send, to the link aggregation peer, an indication that the supplicant device is locally connected (e.g., connected at the local interface of the network device on which the supplicant device is authenticated). For example, the operations performed at block 56 may include the operations performed by processing circuitry 24 of device 10-1 in FIG. 4, in connection with the transmission of update message 40 to processing circuitry 24 of device 10-2.

After the operations at block 56 and before the operations at block 58, the authenticated supplicant device may have been moved from a network location characterized by being authenticated on and connected at an input-output interface of the network device to another network location characterized by being authenticated on and connected at an input-output interface of the link aggregation peer.

At block 58, the one or more processors may receive, from the link aggregation peer, an indication that the supplicant device is peer-connected (e.g., connected at an interface of the link aggregation peer). For example, the operations performed at block 58 may include the operations performed by processing circuitry 24 of device 10-1 in FIG. 5, in connection with the reception (and subsequent processing) of update message 44 from processing circuitry 24 of device 10-2.

At block 60, the one or more processors may remove the stored indication that the supplicant device is locally authenticated. For example, the operations performed at block 60 may include the operations performed by processing circuitry 24 of device 10-1 in FIG. 5, in connection with the removal of entry 33-1 (serving as the stored indication) from database 32-1 of local authenticated devices.

Based at least in part on the operations at blocks 58 and/or 60 (e.g., based on received message 44 and stored entry 33-1 identifying the same authenticated device), the one or more processors of the network device (e.g., network device 10-1) may detect the authenticated device move.

At block 62, the one or more processors may send, to the link aggregation peer, an indication that the supplicant device is not locally connected (e.g., not connected to the local interface of the network device). For example, the operations performed at block 62 may include the operations performed by processing circuitry 24 of device 10-1 in FIG. 6, in connection with the transmission of update message 50 to processing circuitry 24 of device 10-2.

Based at least in part on the operations at block 60 and/or 62 (e.g., based on removing entry 33-1 and updating the link aggregation peer on the non-connectivity of the authenticated device), the one or more processors may update the device state to appropriate reflect the authenticated device move.

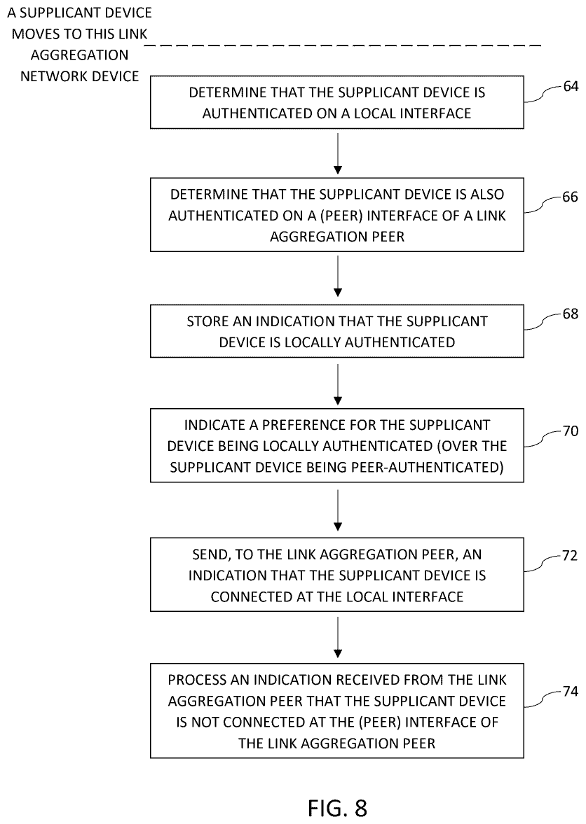

FIG. 8 is a flowchart of illustrative operations performed by one or more network devices such as network devices 10-1 and/or 10-2. The illustrative operations described in connection with FIG. 8 may be performed by one or more processors (e.g., processing circuitry 24 in FIG. 2) in the corresponding network device by executing software instructions stored on respective memory circuitry (e.g., memory circuitry 26 in FIG. 2, including one or more non-transitory computer-readable media). If desired, one or more operations described in connection with FIG. 8 may be performed by other dedicated hardware components in the respective network device.

In some illustrative configurations, the operations described in connection with FIG. 8 may occur after the operations described in connection with block 56 in FIG. 7 (e.g., after the authenticated device move has occurred).

At block 64, one or more processors of a network device, such as a network device implementing a link aggregation peer group with its link aggregation peer, may determine that the supplicant device is authenticated on a local interface of the network device. For example, the operations performed at block 64 may include the operations performed by processing circuitry 24 of device 10-2 in FIG. 5, in connection with the authentication of device 20 on a given input-output interface 30 of device 10-2.

At block 66, the one or more processors may determine that the supplicant device is also authenticated on a (peer) interface of a link aggregation peer. For example, the operations performed at block 66 may include the operations performed by processing circuitry 24 of device 10-2 in FIG. 5, in connection with the determination that entry 35-2 exists in database 34-2 (e.g., was added in connection with the operations of FIG. 4). In particular, entry 35-2 for an authenticated device may serve as an indication that the authenticated device was also authenticated on an input-output interface 30 of network device 10-1.

Based at least in part on the operations at blocks 64 and/or 66 (e.g., based on the locally authenticated device already being identified as a peer-authenticated (and/or a peer-connected) device), the one or more processors of the network device (e.g., network device 10-2) may detect the authenticated device move.

At block 68, the one or more processors may store an indication that the supplicant device is locally authenticated (e.g., authenticated for network access on the local interface of the network device). For example, the operations performed at block 68 may include the operations performed by processing circuitry 24 of device 10-2 in FIG. 5, in connection with the storage of entry 33-2 (serving as the stored indication) in database 32-2 of local authenticated devices.

At block 70, the one or more processors may indicate a preference for the supplicant device being locally authenticated (over the supplicant device being peer-authenticated). For example, the operations performed at block 68 may include the operations performed by processing circuitry 24 of device 10-2 in FIG. 5, in connection with the assignment of a higher preference (value) for entry 33-2 compared to the preference (value) for entry 35-2.

At block 72, the one or more processors may send, to the link aggregation peer, an indication that the supplicant device is locally connected (e.g., connected at the local interface of the network device on which the supplicant device is authenticated). For example, the operations performed at block 72 may include the operations performed by processing circuitry 24 of device 10-2 in FIG. 5, in connection with the transmission of update message 44 to processing circuitry 24 of device 10-1.

At block 74, the one or more processors may further receive an indication from the link aggregation peer that the supplicant device is not peer-connected (e.g., not connected at or authenticated on an interface of the link aggregation peer) and process the received indication. For example, the operations performed at block 74 may include the operations performed by processing circuitry 24 of device 10-2 in FIG. 6, in connection with the reception and processing of update message 50 from processing circuitry 24 of device 10-1.

The methods and operations described above in connection with FIGS. 1-8 may be performed by the components of one or more network devices and/or server or other host equipment using software, firmware, and/or hardware (e.g., dedicated circuitry or hardware). Software code for performing these operations may be stored on non-transitory computer-readable storage media (e.g., tangible computer-readable storage media) stored on one or more of the components of the network device(s) and/or server or other host equipment. The software code may sometimes be referred to as software, data, instructions, program instructions, or code. The non-transitory computer readable storage media may include drives, non-volatile memory such as non-volatile random-access memory (NVRAM), removable flash drives or other removable media, other types of random-access memory, etc. Software stored on the non-transitory computer readable storage media may be executed by processing circuitry on one or more of the components of the network device(s) and/or server or other host equipment (e.g., by respective processing circuitry 24 in network devices 10-1 and 10-2).

The foregoing is merely illustrative and various modifications can be made to the described embodiments. The foregoing embodiments may be implemented individually or in any combination.

What is claimed is:

1. A network device operable to implement one or more link aggregation groups with a link aggregation peer, the network device comprising:
an input-output interface;
memory circuitry; and
processing circuitry coupled to the input-output interface and to the memory circuitry and configured to:
determine that a supplicant device is connected to and authenticated for network access on the input-output interface;
store an indication that the supplicant device is authenticated on the input-output interface;
while the indication that the supplicant device is authenticated is stored, receive, from the link aggregation peer, an indication that the supplicant device is connected at a peer input-output interface of the link aggregation peer; and
based on the received indication, remove the stored indication that the supplicant device is authenticated on the input-output interface.

2. The network device defined in claim 1, wherein the processing circuitry is configured to send, to the link aggregation peer, an indication that the supplicant device is connected at the input-output interface based on the stored indication that the supplicant device is authenticated on the input-output interface.

3. The network device defined in claim 2, wherein the processing circuitry is configured to send, to the link aggregation peer, an indication that the supplicant device is not connected at the input-output interface based on the indication that the supplicant device is authenticated on the input-output interface being removed.

4. The network device defined in claim 3, wherein the processing circuitry is configured to send update messages indicating locally-connected devices to the link aggregation peer when performing link aggregation group management operations, wherein a first of the update messages comprises the indication that the supplicant device is connected at the input-output interface, and wherein a second of the updates comprises the indication that the supplicant device is not connected at the input-output interface.

5. The network device defined in claim 1, wherein the indication that the supplicant device is authenticated on the input-output interface is stored prior to a move of the supplicant device to the link aggregation peer.

6. The network device defined in claim 5, wherein the indication that the supplicant device is connected at the peer input-output interface of the link aggregation peer is received after the move of the supplicant device to the link aggregation peer.

7. The network device defined in claim 1, wherein the processing circuitry is configured to maintain a database of local authenticated devices when performing network access control operations and wherein an entry in the database comprises the indication that the supplicant device is authenticated on the input-output interface.

8. A network device operable to implement one or more link aggregation groups with a link aggregation peer, the network device comprising:
an input-output interface;
memory circuitry; and
processing circuitry coupled to the input-output interface and to the memory circuitry and configured to:
determine that a supplicant device is authenticated for network access on the input-output interface;
determine that the supplicant device is connected to and authenticated for network access on a peer input-output interface of the link aggregation peer;
based on the supplicant device being authenticated on the peer input-output interface of the link aggregation peer and the input-output interface, indicate a preference for the supplicant device being locally authenticated over the supplicant device being peer-authenticated; and
provide an entry indicative of the supplicant device being locally authenticated based on the indicated preference.

9. The network device defined in claim 8, wherein the processing circuitry is configured to store the entry in a database of local authenticated devices and wherein the entry is indicative of the supplicant device being authenticated on the input-output interface.

10. The network device defined in claim 9, wherein the processing circuitry is configured to send, to the link aggregation peer, an indication that the supplicant device is connected at the input-output interface based on the supplicant device being connected to or authenticated on the input-output interface.

11. The network device defined in claim 10, wherein the processing circuitry is configured to receive, from the link aggregation peer, an indication that the supplicant device is not connected to the peer input-output interface of the link aggregation peer.

12. The network device defined in claim 11, wherein the processing circuitry is configured to exchange update messages of locally-connected devices with the link aggregation peer when performing link aggregation group management operations, wherein a first of the update messages comprises the indication that the supplicant device is connected at the input-output interface, and wherein a second of the update messages comprises the indication that the supplicant device is not connected to the peer input-output interface of the link aggregation peer.

13. The network device defined in claim 11, wherein the processing circuitry is configured to:
store an indication that the supplicant device is connected at the peer input-output interface of the link aggregation peer, prior to the supplicant device being authenticated on the input-output interface; and
process the received indication that the supplicant device is not connected to the peer input-output interface of the link aggregation peer by removing the stored indication that the supplicant device is connected at the peer input-output interface of the link aggregation peer.

14. The network device defined in claim 9, wherein the processing circuitry is configured to maintain the database of local authenticated devices when performing network access control operations.

15. The network device defined in claim 8, wherein the supplicant device is authenticated on the peer input-output interface of the link aggregation peer prior to being authenticated on the input-output interface.

16. A method of handling a move of a device authenticated for network access on a first link aggregation peer to a second link aggregation peer, the method comprising:
receiving, from the first link aggregation peer and by the second link aggregation peer, an indication that the device is connected to an input-output interface of the first link aggregation peer;
storing, by the second link aggregation peer, the indication;
while the indication is stored, connecting, by the second link aggregation peer, to the device on an input-output interface of the second link aggregation peer, wherein the device is connected to the input-output interface of the second link aggregation peer for network access via the input-output interface of the second link aggregation peer; and
sending, by the second link aggregation peer and to the first link aggregation peer, an indication that the device is connected to the input-output interface of the second link aggregation peer based on the device being connected for network access via the input-output interface of the second link aggregation peer.

17. The method defined in claim 16 further comprising:
identifying, by the second link aggregation peer, the move of the device to the second link aggregation peer based on the indication that the device is connected to the input-output interface of the first link aggregation peer and based on the device being connected for network access via the input-output interface of the second link aggregation peer.

18. The method defined in claim 16 further comprising:
authenticating, by the second link aggregation peer, the network device for network access on the input-output interface of the second link aggregation peer; and
indicating, by the second link aggregation peer, a preference for the device being authenticated on the input-output interface of the second link aggregation peer over the device being authenticated on the input-output interface of the first link aggregation peer.

19. The method defined in claim 18 further comprising:
storing an indication that the device is authenticated on the input-output interface of the second link aggregation peer, wherein the indication that the device is connected to the input-output interface of the second link aggregation peer is sent based on the device being authenticated on the input-output interface of the second link aggregation peer.

20. The method defined in claim 16 further comprising:
receiving, from the first link aggregation peer and by the second link aggregation peer, an indication that the device is no longer connected to the input-output device of the first link aggregation peer; and
authenticating, by the second link aggregation peer, the network device for network access on the input-output interface of the second link aggregation peer based on the received indication that the device is no longer connected to the input-output device of the first link aggregation peer.
